(19) United States
(12) Patent Application Publication
(10) Pub. No.: US 2002/0131114 A1
(43) Pub. Date: Sep. 19, 2002

(54) Method and apparatus for optical signal processing using subcarrier multiplexed headers

(75) Inventor: Sung-Joo Yoo, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of The University of California, Oakland, CA (US)

(21) Appl. No.: 10/075,780

(22) Filed: Feb. 12, 2002

Related U.S. Application Data
(60) Provisional application No. 60/276,632, filed on Mar. 15, 2001.

(51) Int. Cl. H04J 14/02

(52) U.S. Cl. 359/124; 359/128

(57) ABSTRACT

Method and corresponding apparatus for extraction and rewriting of subcarrier multiplexed (SCM) signals such as optical header labels from a SCM/mixed baseband optical signal, amd routing of the baseband optical signal on the basis of the extracted header information. The method comprises applying an SCM/mixed baseband signal to a fiber Bragg grating (FBG) filter from which is extracted a modulated signal at information-bandwidth limited photoreceivers tapped to an optical signal path via an optical circulator (OC), causing the SCM optical signal to be stripped from the baseband optical signal. The method further comprises directing the baseband signal through a wavelength converting router in accordance with the information in the extracted SCM signal and writing a new SCM signal onto the baseband signal.

### CROSS-REFERENCES TO RELATED APPLICATIONS

The present application claims benefit of Provisional Application No.: 60/276,632 filed Mar. 15, 2001. All material from that application is incorporated herein by reference.

### STATEMENT AS TO RIGHTS TO INVENTIONS MADE UNDER FEDERALLY SPONSORED RESEARCH AND DEVELOPMENT

The work on this invention was partially funded by the Defense Advanced Research Projects Agency (DARPA) and Air Force Research Laboratory under agreement No. F30602-00-2-0543 and the National Science Foundation grant No. ANI-998665. The United States Government may have certain rights in this invention.

### BACKGROUND OF THE INVENTION

This invention relates to optical signal processing and more particularly to methods and apparatus for manipulating a SCM/mixed baseband optical signal by extracting and rewriting its subcarrier multiplexed (SCM) header signal and routing the baseband signal on the basis of the data contained in the SCM header.

While the integration of data networking and optical networking is a key to the next generation optical Internet, all-optical signal processing techniques involving optical headers are still premature for practical system applications. All-optical signal routing control has been suggested through the technique of Optical Label switching. Optical Label switching incorporates a short optical label at wavelengths adjacent a data signal wavelength, the label containing routing information in its modulation. There are two key challenges in implementing Optical-Label switching systems and routers. First there is a stringent requirement for viable optical header processing and optical switching technologies, specifically, optical label switching networks will require a simple and effective method to swap headers in real time without affecting the data payload in order to achieve low-latency packet forwarding and routing. Second, there is the challenge of involving as little electronic processing as possible. Subcarrier multiplexed (SCM) header techniques meet both these requirements by allowing relatively easy separation of the of the subcarrier header from the baseband data payload compared to conventional time domain header techniques.

Separation of the SCM header from the baseband data payload is achieved in the art by operations either in the electrical domain after optical to electrical conversion or directly in the optical domain. A method is known for optically filtering a single side-band (SSB) SCM header. This optical domain method requires the use of a sophisticated SSB-SCM transmitter design involving quadrature modulation of a dual-arm LiNbO₃ modulator. However, it is not adapted for filtering dual side-band SCM headers. Another optical filtering method is known using an optical loop mirror incorporating a birefringent fiber. This method can simultaneously extract multiple headers on multiple wavelengths, but it requires a very precise design of a bulky loop mirror filter. In addition, insufficient attenuation between the SCM and the baseband signal due to a very narrow notch filter bandwidth is a key obstacle for the fiber loop mirror method. Moreover, both the known all-optical SCM filtering methods have sinusoidal spectral transmission functions. This prevents such filtering methods from being used in Dense Wavelength Division Multiplexing (DWDM) applications wherein there are multiple signal of varying, though closely spaced, wavelengths, which all must be separated from their respective headers simultaneously.

What is needed is a practical optically-compatible technique for extraction of subcarrier multiplexed (SCM) signal from a modulated baseband optical signal, routing of the baseband signal on the basis of the data contained in the SCM signal, and rewriting a new SCM signal on the old baseband signal for further processing.

### SUMMARY OF THE INVENTION

According to the invention, a method and an apparatus are provided for extraction of subcarrier multiplexed (SCM) signals such as optical header labels from a SCM/mixed baseband optical signal. The method provides further for the routing of the baseband optical signal in accordance with the information contained in the SCM signal and for the remodulation of the baseband signal to add a new SCM component. The method comprises applying an SCM/mixed baseband signal to a fiber Bragg grating (FBG) filter from which is extracted a modulated signal at information bandwidth limited photoreceivers tapped to an optical signal path via an optical circulator (OC), causing the SCM optical signal to be stripped from the baseband optical signal. After the SCM has been extracted from the SCM/mixed baseband signal, the remaining baseband signal is routed according to the information contained in the SCM signal, and it can be re-modulated to add a new SCM signal.

The invention provides a polarization-independent and dispersion-insensitive all-optical technique for extracting an SCM signal, and it permits the implementation of practical all-optical Optical Label switching.

The invention will be better understood by reference to the following detailed description in connection with the accompanying drawings.

### BRIEF DESCRIPTION OF THE DRAWINGS

FIG. 1 is a block diagram of an optical subcarrier receiver according to the invention, and it incorporates illustrations of the optical spectrum associated with each input port, output port and signal extraction port of the invention.

FIG. 2 is a block diagram showing an optical router that extracts an SCM header from a baseband data payload and based on the data contained in the SCM header, changes the wavelength of the baseband signal, routs the baseband signal through an array waveguide grating acting as a wavelength switch, and rewrites a new optical header.

### DETAILED DESCRIPTION OF THE INVENTION

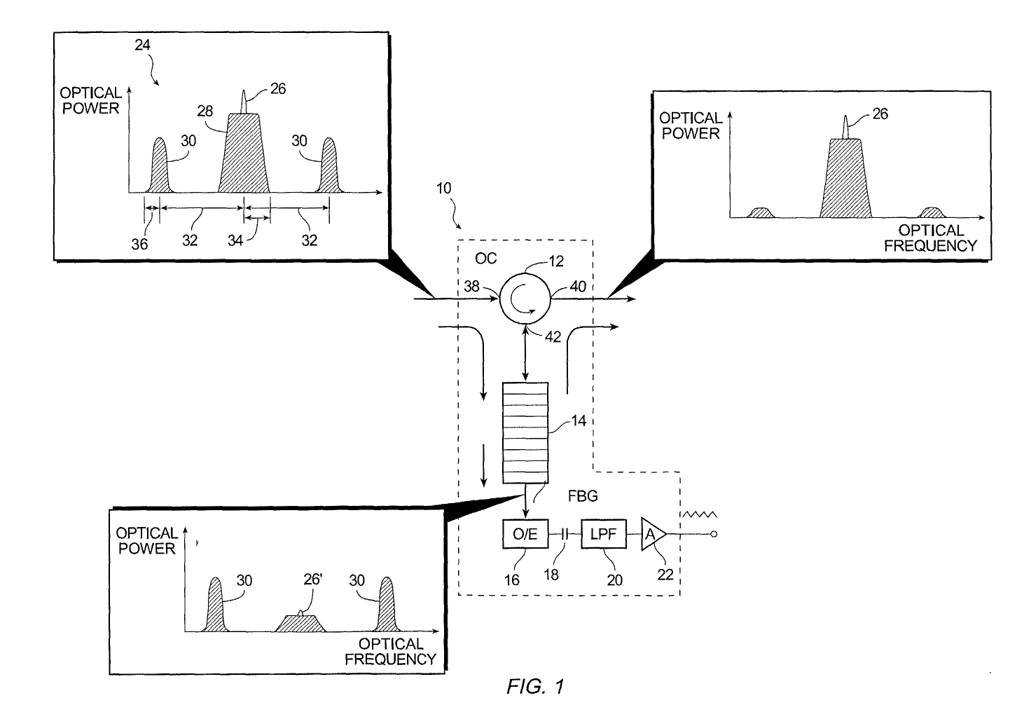

Referring to FIG. 1 there is shown an optical subcarrier receiver 10 comprising an optical circulator 12, a fiber Bragg grating 14, an optical energy transducer 16 such as a photodetector, and associated signal detection electronics. This may include an a.c. coupling capacitor 18, an electric lowpass filter 20 and an electric output amplifier 22 which together form a simple square law detector, also known as an envelope detector, for detecting the amplitude modulation on the signal received at the photodetector. Other forms of detection will be evident to those of skill in the art.

Input 38 to the receiver is a subcarrier multiplexed baseband optical signal 24 which includes a modulated optical carrier 26 for a payload 28 and a modulated optical subcarrier 30 for carrying control information, such as header information for routing packet traffic on an optical network where signals are routed through the optical circulator 12 from its input 38 to its output 40. The modulated optical subcarrier 30 is doubled sideband modulated at a subcarrier frequency 32 relative to the frequency of the carrier 26 which is greater than the modulation bandwidth 34 of the optical carrier and the information bandwidth 36 of the subcarrier 30.

In a specific embodiment, the fiber Bragg grating (FBG) 14 receives input from an extraction port 42 of the optical circulator 12 with higher than 99.95% peak reflectivity with a pass band below 10 GHz full width at half maximum. The FBG 14 according to the invention is a compact package that may be temperature compensated to minimize drift in the peak wavelength with age and ambient conditions. Both the FBG wavelength, selected to separate the subcarrier 30 and the carrier 26 wavelengths in a typical embodiment may have the carrier centered close to the wavelength of 1560.1 nm. The structure in FIG. 1 allows reflection of a data payload, namely the modulated subcarrier 28, as indicated as a suppressed modulated carrier 26′ at the output of the FBG 14 as well as transmission of the subcarrier 30 containing control or header information by the FBG 14. The two signal components are easily separated by using the optical circulator 12 to pass only the modulated carrier 26 through the output 40 of the circulator 12.

In another embodiment an optical modulation means is coupled to the output 40 of the subcarrier receiver in order to encode a new SCM header onto the retained data payload. In a specific embodiment this optical modulations comprises a 10 Gb/s LiNbO3 Mach Zender modulator coupled to a programmable pulse generator but other forms of modulating an optical signal will be evident to those skilled in the art.

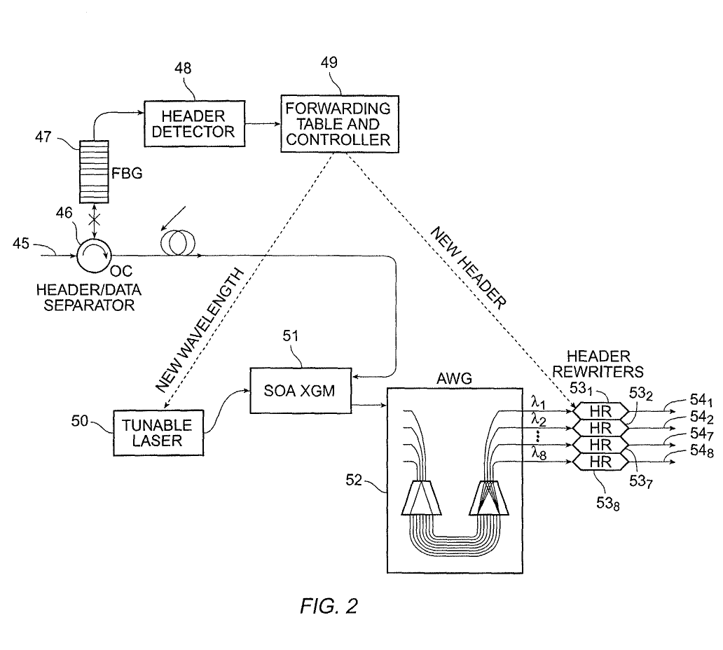

Referring to FIG. 2, there is shown a wavelength converting, optical label switching, optical packet router comprising an input 45, a subcarrier receiver as depicted in FIG. 1, a forwarding table and controller 49, a rapidly tunable laser 50, a semiconductor optical amplifier 51, an array waveguide grating 52, and an array of header rewriters 53₁-53₈ and an array of corresponding outputs 54₁-54₈.. The subcarrier receiver itself comprises an optical circulator 46 with one input port and two output ports, a fiber Bragg grating (FBG) arranged at one output port to the circulator and a header detector, which is an optical to electrical transducer for detecting and converting the optical signal into an electrical signal. In one specific embodiment, the header detector comprises a photodetector coupled to a capacitor, a low pass filter, and an amplifier. Other optical detection devices will be evident to those skilled in the art.

Input 45 to the router is a subcarrier multiplexed baseband optical signal which includes a modulated optical carrier for a payload and a modulated optical subcarrier for carrying control information, such as header information for routing packet traffic on an optical network. The signal is applied by the optical circulator 46 to the FBG 47. The FBG reflects the data payload signal and transmits the SCM header signal to the header detector 48. The header detector 48 is coupled to a forwarding table and controller 49 which determines the new destination and wavelength of the routed data signal.

Based on the header information extracted by the subcarrier receiver, control signals are sent to a rapidly tunable laser 50 which is adjusted so that it emits light of a wavelength indicated by the header information. In one specific embodiment the tunable laser supports a 45 nm range between 1525 nm and 1570 nm. The output from the tunable laser 50 is directed to a semiconductor optical amplifier (SOA) 51. The modulated carrier signal for data payload from the optical subcarrier receiver is also directed to the SOA 51 such that it propagates through the SOA's gain medium in a direction opposite the direction of propagation of the light emitted by the tunable laser. This counter-propagating geometry avoids the need for using an optical filter for transmitting tunable laser output, and also provides additional bandwidth limit to further reduce leakage of the subcarrier header at the higher modulation frequency. Other means of modulating the tunable source's output such that it becomes proportional to the modulation of the data signal are possible. For example, in another specific embodiment, the inversion of the data payload modulation resulting from the counter propagating geometry is corrected by cascading another inverting wavelength converter not shown in tandem with the first SOA 51.

The output of SOA 51 is coupled to an input of an array waveguide grating (AWG) 52. The AWG 52 is a device for dividing the optical power of a signal at an input port among a plurality of output ports in accordance with the spectral content of the input signal. Illuminating an input port of an AWG with a spectrally broad signal will result in light of different wavelengths being emitted simultaneously at a plurality of corresponding outputs. Illuminating an input port of an AWG with a spectrally narrow source can result in light being emitted at as few as one AWG output ports. When used with very narrow spectral sources, an AWG acts as a wavelength switch, directing light from an input to a specific output depending on the wavelength on the input light. In one specific embodiment, an AWG with 8 inputs and 8 outputs is used. Other types of AWGs and other types of wavelength switches will be evident to those of reasonable skill in the art.

The combination of a the tunable laser 50 and the AWG 52 allows the data payload signal to be switched among the various outputs of the AWG as dictated by the information contained in the subcarrier header.

In one specific embodiment, the AWG outputs are each coupled to header rewriters 53₁-53₈. In one embodiment, the header rewriters are LiNbO3 modulators coupled to signal generating electronics. The header rewriters 53₁-53₈ receive data from the forwarding table and controller 49 and write new SCM header information onto the switched data payload signal in accordance with the data content of the original header. After acquiring new header information, the switched signal propagates out of the router along one of a plurality of outputs 54₁-54₈.

The invention have been explained with reference to specific embodiments. Other embodiments will be evident to those of ordinary skill in the art. It is therefore not intended that this invention be limited, except as indicated by the appended claims.

What is claimed is:

1. A method for extracting information in an optical subcarrier of a subcarrier multiplexed baseband optical signal, the subcarrier multiplexed baseband optical signal comprising a modulated optical carrier for a payload and a modulated optical subcarrier for control information, the modulated optical subcarrier being at a subcarrier frequency which is separated from the modulation bandwidth of the optical carrier, the method comprising:
receiving the subcarrier multiplexed baseband optical signal at an input port of an optical circulator;
applying the subcarrier multiplexed baseband optical signal via an extraction port of the optical circulator to a fiber Bragg grating;
optically separating the modulated optical subcarrier in the fiber Bragg grating and directing the modulated optical subcarrier to an optical energy transducer while reflecting the modulated optical carrier back to the extraction port of the optical circulator; and
outputting the modulated optical carrier to an output port of the optical circulator.

2. The method according to claim 1 further comprising:
outputting a modulated electrical signal from the optical transducer which is proportional to modulation of the modulated optical signal; and
detecting the information modulating the electrical signal.

3. A method for swapping control information of a subcarrier multiplexed baseband optical signal, the subcarrier multiplexed baseband optical signal comprising a modulated optical carrier for a payload and a modulated optical subcarrier for control information, the modulated optical subcarrier being at a subcarrier frequency which is separated from the modulation bandwidth of the optical carrier, the method comprising:
separating the modulated optical carrier from the modulated optical subcarrier according to the method of claim 1; and
applying the modulated optical carrier to an optical modulator adapted for writing new subcarrier modulated control information.

4. A method for controlling the propagation path of a subcarrier multiplexed baseband optical signal comprising a modulated optical carrier for a payload and a modulated optical subcarrier for control information, the modulated optical subcarrier being at a subcarrier frequency which is separated from the modulation bandwidth of the optical carrier, the method comprising:
receiving the signal at the input to a routing element;
extracting the modulated optical subcarrier control information according to the method of claim 2;
changing the wavelength of the optical carrier for the payload in response to the control information; and
directing the optical carrier for the payload along one of a plurality of output paths from the routing element responsive to the control information.

5. The method according to claim 4 further comprising the step of modulating the directed optical carrier to add a subcarrier containing new control information.

6. A device for extracting information in an optical subcarrier of a subcarrier multiplexed baseband optical signal, the subcarrier multiplexed baseband optical signal comprising a modulated optical carrier for a payload and a modulated optical subcarrier for control information, the modulated optical subcarrier being at a subcarrier frequency which is separated from the modulation bandwidth of the optical carrier, the device comprising:
an optical circulator having an input port for receiving the subcarrier multiplexed baseband optical signal, a bi-directional extraction port and an output port;
a fiber Bragg grating optically coupled to said extraction port of said optical circulator for optically separating the modulated optical subcarrier from the subcarrier multiplexed baseband optical signal and reflecting the modulated optical carrier to the optical circulator; and
an optical energy transducer optically coupled to receive the modulated optical subcarrier.

7. The device according to claim 3 wherein the optical energy transducer is a photodetector for generating a electrical signal proportional to the signal of the modulated subcarrier and further including:
a detector for detecting the information modulating the electrical signal.

8. A device for swapping control information of a subcarrier multiplexed baseband optical signal, the subcarrier multiplexed baseband optical signal comprising a modulated optical carrier for a payload and a modulated optical subcarrier for control information, the modulated optical subcarrier being at a subcarrier frequency which is separated from the modulation bandwidth of the optical carrier, the device comprising:
an optical subcarrier receiver according to claim 6 and a means for modulating the modulated optical carrier to add new information contained in a new modulated optical subcarrier.

9. An optical routing device adapted for controlling the wavelength and manner of propagation of a subcarrier multiplexed baseband optical signal, said subcarrier multiplexed baseband optical signal comprising a modulated optical carrier for a payload and a modulated optical subcarrier for control information, the modulated optical subcarrier being at a subcarrier frequency which is separated from the modulation bandwidth of the optical carrier, the routing element comprising:
an optical subcarrier receiver according to claim 7;
a controller for controlling other components in response to the control information extracted by said optical subcarrier receiver; and
a tunable optical source coupled to said controller, adapted for emitting an optical signal with a modulation proportional to the modulated optical carrier at a wavelength dictated by the control information on the said control information.

10. The device of claim 9 wherein the tunable optical source comprises:
a tunable laser optically coupled to a semiconductor optical amplifier.

11. The device of claim 9 further comprising a wavelength switch having at least one input and a plurality of outputs, the switch being optically coupled to the tunable optical source and adapted for directing an optical signal on any of its inputs to a specific output in accordance with the wavelength of the input signal.

12. The device of claim 11 wherein the wavelength switch is an array waveguide grating.

13. The device of claim 11 further comprising an array of optical modulators coupled to the outputs of the wavelength switch, said modulators adapted for further modulating the modulated optical carrier signal to addadditional information.
